(19) United States
(12) Patent Application Publication
(10) Pub. No.: US 2017/0168996 A1
(43) Pub. Date: Jun. 15, 2017

(54) SYSTEMS AND METHODS FOR WEB PAGE LAYOUT DETECTION

(71) Applicant: Quad Analytix LLC, San Mateo, CA (US)

(72) Inventors: Xinghua Dou, Berkeley, CA (US); Karan Jindal, Karmal (IN); Sreenivasan Iyer, San Ramon, CA (US); Nitin Jain, Noida (IN); Anurag Bhardwaj, Sunnyvale, CA (US)

(21) Appl. No.: 15/373,261

(22) Filed: Dec. 8, 2016

(30) Foreign Application Priority Data
Dec. 9, 2015 (IN) 4005/DEL/2015

(51) Int. Cl. G06F 17/21; G06K 9/00; G06F 17/22

(52) U.S. Cl. CPC G06F 17/212; G06F 17/2247; G06F 17/218; G06K 9/00463; G06K 9/00456

(57) ABSTRACT

Examples of the systems and methods described herein relate to methods, systems, and apparatus for automatically detecting layouts or web pages and/or extracting information from the web pages, based on the detected layouts. An example computer-implemented method includes: loading a web page; identifying one or more candidate elements on the web page according to at least one of a padding constraint, a grouping constraint, and a size constraint; determining a plurality of features for the one or more candidate elements, the features including at least one of a dimension feature, a content feature, and a background feature; providing the plurality of features as input to one or more classifiers; and receiving as output from the one or more classifiers an identification of one or more information elements on the web page, the information elements including information of interest to one or more users.

### CROSS-REFERENCE TO RELATED APPLICATIONS

This application claims priority to Indian Provisional Patent Application No. 4005/DEL/2015, filed Dec. 9, 2015, the entire contents of which are incorporated by reference herein.

### BACKGROUND

This specification relates to improvements in computer functionality and, in particular, to improved computer-implemented systems and methods for automatically detecting layouts of web pages and extracting information of interest from the web pages, based on the detected layouts.

Automated web extraction is the process of extracting numerical values, text, and other data of interest from Internet web pages. Vast amounts of online data, numerical values, commentary, and associated trends provide an opportunity for researchers, scientists, and entrepreneurs to evaluate such data and generate powerful insights. The disorganized or non-standard nature of the web, however, makes extracting and normalizing such data extremely difficult.

Traditional approaches to solving the web extraction problem rely on manually written wrappers (e.g., custom Hypertext Markup Language tag sets) to extract data from individual web pages. These wrappers can provide a specific way to navigate and mine web pages using properties such as Hypertext Markup Language (HTML) Document Object Model (DOM) elements and Cascading Style Sheets (CSS) selectors as beacons. Given the large variety of web site formats and layouts, however, manual wrappers are ill-suited to the task of large-scale, automated web data extraction. This problem is further compounded by frequent changes to websites and web page layouts, which can render manual wrappers ineffective and/or useless.

There is a need for systems and methods that enable robust and efficient web page extraction for the wide range of web page formats and layouts.

The foregoing discussion, including the description of motivations for some embodiments of the invention, is intended to assist the reader in understanding the present disclosure, is not admitted to be prior art, and does not in any way limit the scope of any of the claims.

### SUMMARY

In general, the systems and methods described herein can be used to automatically detect web page layouts and extract information of interest for a wide range of websites and web pages related to various types of subject matter, including news, current events, science, mathematics, social media, blogs, and e-commerce. Examples of the systems and methods use a multi-phase feature design scheme that optimizes both on accuracy and computation time. A computationally efficient pruning operation can be used to identify candidate elements on a web page that may include information of interest. A set of features can be then extracted from the candidate elements, and the features can be input into a trained classifier to obtain a final determination of the web page elements that include the information of interest. Experimental measurements across a variety of different web page formats and layouts illustrate the improved accuracy and efficiency of the systems and methods, compared to prior approaches.

In one aspect, the subject matter of this disclosure relates to a computer-implemented method of detecting a web page layout. The method includes: loading a web page; identifying one or more candidate elements on the web page according to at least one of a padding constraint, a grouping constraint, and a size constraint; determining a plurality of features for the one or more candidate elements, the features including at least one of a dimension feature, a content feature, and a background feature; providing the plurality of features as input to one or more classifiers; and receiving as output from the one or more classifiers an identification of one or more information elements on the web page, the information elements including information of interest to one or more users.

In certain examples, loading the web page includes loading the web page in a browser. The one or more candidate elements can be identified according to the padding constraint, and the padding constraint can require candidate elements to have a consistent spacing (e.g., less than 5%, 10% or 20% variation). Alternatively or additionally, the one or more candidate elements can be identified according to the grouping constraint, and the grouping constraint can require (i) candidate elements to form a group (e.g., share a parent DOM tag, or be arranged in proximity to one another) and (ii) each candidate element in the group to include at least one of a unique color, a unique image, and unique text. Alternatively or additionally, the one or more candidate elements can be identified according to the size constraint, and the size constraint can require candidate elements to include a size (e.g., a dimension or area) that falls within a specified range (e.g., in pixels or pixels squared).

In some instances, the features include the dimension feature, which can include a web page height, a web page width, an x-coordinate, a y-coordinate, a height H, and/or a width W. The features can include the content feature, which can include, for example, a number of colors, a number of fonts, a number of images, a type of text, and/or a length of text. The features can include the background feature, which can include, for example, a number of background colors and/or a number of background images.

In certain implementations, extracting features includes traversing a tag tree in the web page. The one or more classifiers can use or include, for example, a one-class support vector machines algorithm. The one or more candidate elements can include the one or more information elements. The method can include training the classifier with training data that includes features for web page elements (e.g., information elements and/or non-information elements). The method can include extracting information of interest from at least one of the one or more information elements.

In another aspect, the subject matter of this disclosure relates to a system that includes a data processing apparatus programmed to perform operations for detecting a web page layout. The operations include: loading a web page; identifying one or more candidate elements on the web page according to at least one of a padding constraint, a grouping constraint, and a size constraint; determining a plurality of features for the one or more candidate elements, the features including at least one of a dimension feature, a content feature, and a background feature; providing the plurality of features as input to one or more classifiers; and receiving as output from the one or more classifiers an identification of one or more information elements on the web page, the information elements including information of interest to one or more users.

In certain instances, the one or more candidate elements are identified according to the padding constraint, and the padding constraint can require candidate elements to have a consistent spacing. Alternatively or additionally, the one or more candidate elements can be identified according to the grouping constraint, and the grouping constraint can require (i) candidate elements to form a group and (ii) each candidate element in the group to include at least one of a unique color, a unique image, and unique text. Alternatively or additionally, the one or more candidate elements can be identified according to the size constraint, and the size constraint can require candidate elements to include a size that falls within a specified range. The one or more classifiers can include, for example, a one-class support vector machines algorithm. The one or more candidate elements can include the one or more information elements.

In another aspect, the subject matter of this disclosure relates to a non-transitory computer storage medium having instructions stored thereon that, when executed by data processing apparatus, cause the data processing apparatus to perform operations for detecting a web page layout. The operations include: loading a web page; identifying one or more candidate elements on the web page according to at least one of a padding constraint, a grouping constraint, and a size constraint; determining a plurality of features for the one or more candidate elements, the features including at least one of a dimension feature, a content feature, and a background feature; providing the plurality of features as input to one or more classifiers; and receiving as output from the one or more classifiers an identification of one or more information elements on the web page, the information elements including information of interest to one or more users.

Elements of embodiments or examples described with respect to a given aspect of the invention can be used in various embodiments or examples of another aspect of the invention. For example, it is contemplated that features of dependent claims depending from one independent claim can be used in apparatus, systems, and/or methods of any of the other independent claims.

The details of one or more embodiments of the subject matter described in this specification are set forth in the accompanying drawings and the description below. Other features, aspects, and advantages of the subject matter will become apparent from the description, the drawings, and the claims.

The foregoing Summary, including the description of advantages of some embodiments, is intended to assist the reader in understanding the present disclosure, and does not in any way limit the scope of any of the claims.

### BRIEF DESCRIPTION OF THE DRAWINGS

FIG. 1 is a schematic diagram of an example system for determining web page layout and extracting data from web pages.

FIG. 2 is a flowchart of an example method for training a classifier and using the trained classifier for determining web page layout and extracting data from web pages.

FIGS. 3, 4, and 5 are schematic diagrams of example candidate elements from one or more web pages.

FIG. 6 is a schematic diagram of an example DOM tag tree for a web page.

FIG. 7 is a flowchart of an example method for determining web page layout and extracting data from web pages.

FIGS. 8A-8D include screenshots of example web pages showing web page elements identified using the systems and methods described herein.

FIG. 9 is a bar graph of prediction accuracy from an experiment performed using the systems and methods described herein.

FIG. 10 is a screenshot of an example web page showing information elements detected using the systems and methods described herein.

### DETAILED DESCRIPTION

It is contemplated that apparatus, systems, and methods embodying the subject matter described herein encompass variations and adaptations developed using information from the examples described herein. Adaptation and/or modification of the apparatus, systems, and methods described herein may be performed by those of ordinary skill in the relevant art.

Throughout the description, where apparatus and systems are described as having, including, or comprising specific components, or where processes and methods are described as having, including, or comprising specific steps, it is contemplated that, additionally, there are apparatus and systems of the present invention that consist essentially of, or consist of, the recited components, and that there are processes and methods according to the present invention that consist essentially of, or consist of, the recited processing steps.

Examples of the systems and methods described herein can be used for automatically detecting and extracting information of interest from web pages, including, for example, scientific web pages, news web pages, blog web pages, and e-commerce web pages. In various examples, an “information element” is understood to mean a web page element that includes information of interest, which may be or include, for example, scientific data, news information, trend information, product information, social network information, etc. In various examples, a “candidate element” is understood to mean a web page element that potentially includes information of interest. As described herein, a pruning technique can be used to identify candidate elements on a web page. Further steps are then taken to determine which, if any, of the candidate elements qualify as information elements. Information of interest can then be extracted from the information elements. In general, a number of information elements on a web page is less than or equal to a number of candidate elements on the web page. Candidate elements and other web page elements that do not qualify as information elements or do not include information of interest can be referred to herein as “non-information elements.”

While the systems and methods described herein are applicable to a wide variety of web pages, in the context of an e-commerce web page, an information element can be defined as a Hypertext Markup Language (HTML) element that corresponds to a unique stock keeping unit (SKU) selection option, which can allow a user to select a product feature, such as color, size, or style. Automated extraction of data from such information elements can allow for more efficient and richer structuring of e-commerce catalogs. Examples of the systems and methods described herein employ a relatively unsupervised and fully automated approach to detecting information elements. In certain examples, the systems and methods use a cascaded feature extraction pipeline, which is both computationally efficient as well as robust to the presence of a large number of noisy or irrelevant HTML elements present in web pages. Additionally or alternatively, the systems and methods can use an outlier detection based scheme that ingests the robust features from the extraction pipeline and builds an efficient model of “regular” or non-information elements.

The systems and methods described herein are generally able to infer information about a web page without first having reviewed or analyzed one or more examples of the web page. One class of techniques that can be used for the web page extraction problem is layout segmentation. Algorithms to segment a web page into multiple sections, such as a header, sidebar, main content, and comments can utilize hard coded heuristics and/or a probability-based approach. One distinguishing feature of such techniques is that the techniques can use visual information in additional to structural information. Features of DOM nodes on the web page, such as height and width, background color, and location on the web page, can be used to group the DOM nodes into various sections. In the context of product pages, for example, many merchants have different kinds of web page layouts for different kinds of products. A product under the category of clothing can have options for size and color, whereas an entry for a chair can have options for different wood finishing. It is generally not feasible for a single wrapper, whether automatically generated or manually specified, to work for an entire web site, much less for the entire web. The clustering of web pages under different types of layouts can be important for making valid wrappers. The systems and methods described herein are generally able to identify information elements across a wide range of web page layouts and categories.

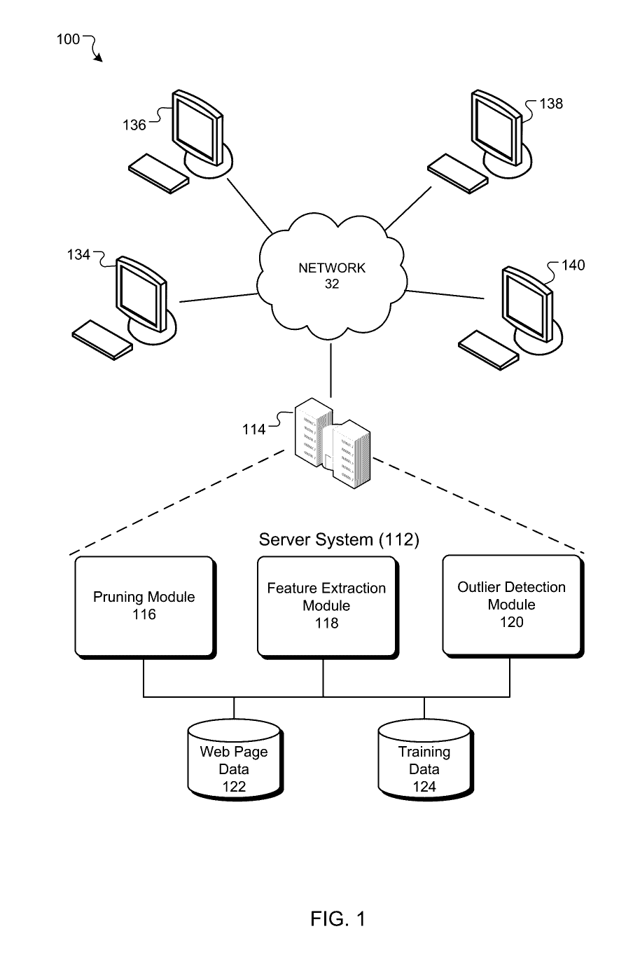

FIG. 1 illustrates an example system 100 for automatic extraction of data from web pages. A server system 112 provides data retrieval, project task analysis, and project monitoring. The server system 112 includes one or more processors 114, software components, and databases that can be deployed at various geographic locations or data centers. The server system 112 software components include a pruning module 116, a feature extraction module 118, and an outlier detection module 120. The software components can include subcomponents that can execute on the same or on different individual data processing apparatus. The server system 112 databases include web page data 122 and training data 124. The databases can reside in one or more physical storage systems. The software components and data will be further described below.

An application having a graphical user interface can be provided as an end-user application to allow users to exchange information with the server system 112. The end-user application can be accessed through a network 32 (e.g., the Internet and/or a local network) by users of client devices 134, 136, 138, and 140. Each client device 134, 136, 138, and 140 may be, for example, a personal computer, a smart phone, a tablet computer, or a laptop computer. In various examples, the client devices 134, 136, 138, and 140 are used to access the systems and methods described herein, to determine web page layouts and extract web page information.

Although FIG. 1 depicts the pruning module 116, the feature extraction module 118, and the outlier detection module 120 as being connected to the databases (i.e., web page data 122 and training data 124), the pruning module 116, the feature extraction module 118, and/or the outlier detection module 120 are not necessarily connected to one or both of the databases. In general, the outlier detection module 120 includes one or more classifiers that can be trained using the training data 124. Information about web pages processed using the system 100 can be stored in the web page data 122. For example, the web page data 122 can include information related to a layout and/or a content of one or more web pages.

In general, the pruning module 116 is used to identify candidate elements on a web page that may include certain information of interest to the users of the system 100. The information of interest may be related to, for example, current events, news, science, sports, products, or services. In one example, the information of interest relates to one or more products being sold on a web page, such as price information, size information, color information, etc. The pruning module 116 preferably scans the web page and identifies the candidate elements on the web page that may include the information of interest. In the process, the pruning module 116 can filter out other elements or features of the web page that do not contain any information of interest and/or do not require further consideration or analysis.

The feature extraction module 118 is generally used to extract features related to the candidate elements. The features may include, for example, a web page dimension (e.g., a web page height and/or width), an element size (e.g., a height and/or a width), an element location (e.g., an x-coordinate and/or a y-coordinate on a web page), a color, a number of colors, a font, a number of fonts, an image, a number of images, a type of text (e.g., numeric, alpha, and/or alphanumeric), a length of text, a background color, a number of background colors, a background image, and/or a number of background images. In one example, the features are extracted programmatically by running a program to calculate one or more appropriate measures for the candidate elements. A web page dimension, for example, can be determined by loading the web page in a browser and calling a browser-based script to determine a height and/or a width of the web page. Additionally or alternatively, features can be computed by running a browser-based script that traverses a tag tree of the web page.

In general, the outlier detection module 120 uses a machine learning classifier or other predictive model to identify any information elements among the candidate elements. The machine learning classifier or other predictive model can be trained using the training data 124, which may be or include, for example, one or more features related to information elements on known or example web pages. In preferred examples, the training data 124 is used to train the machine learning classifier how to recognize information elements among a set of candidate elements. Suitable machine learning classifiers can be or include, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. A preferred classifier is or includes one-class support vector machines. Other classifiers or predictive models can be used.

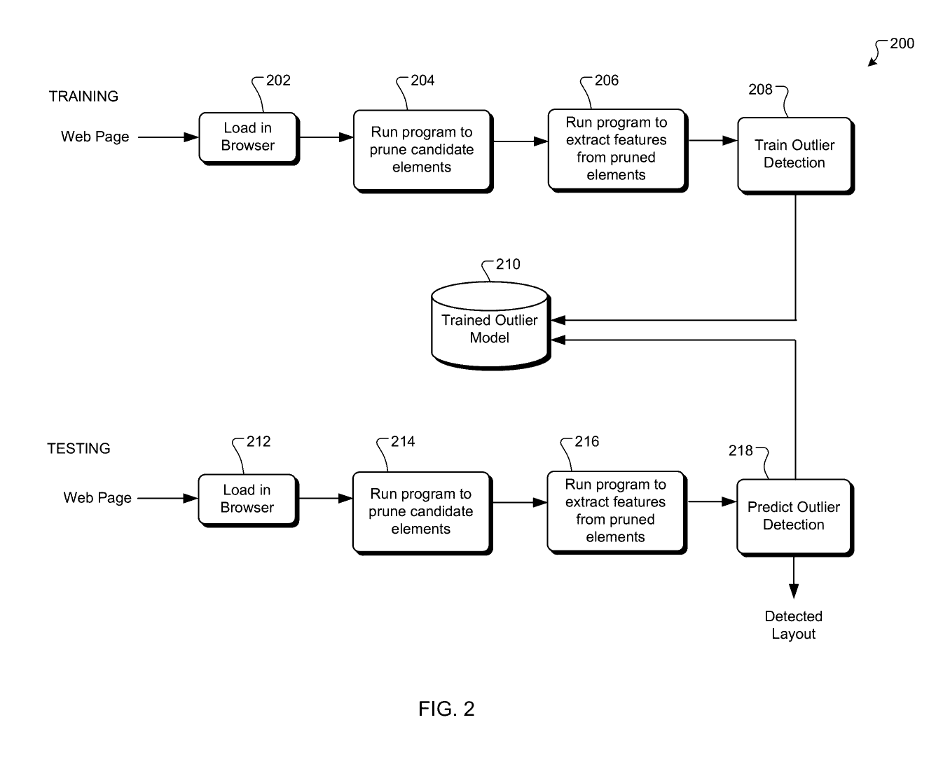

FIG. 2 is a flowchart of an example method 200 for automatic web page layout detection and information extraction. To generate the training data 124, a known or example web page can be loaded into a browser or similar application (step 202). The pruning module 116 can be used to identify any candidate elements on the web page (step 204). The feature extraction module 118 can be used to determine one or more features for the identified candidate elements (step 206) and/or for any other elements on the web page (e.g., non-information elements). One or more information elements can be identified manually and/or automatically, for example, using a classifier or other predictive model. Once the features for the various web page elements have been determined, the features can be added to the training data 124 and used to train one or more classifiers 210 or predictive models in the outlier detection module 120 (step 208). In some examples, the training data includes features for elements that are information elements and features for elements that are non-information elements. A wide variety of training data, for different types of elements, is generally preferable and improves the ability of the classifier to distinguish possible information elements from non-information elements. Alternatively or additionally, the training data can include features for only information elements or for only non-information elements.

Once the one or more classifiers 210 have been trained, the systems and methods described herein can be used to determine the layout of web pages and/or extract information of interest from the web page. For example, a new web page (e.g., a web page for which the layout is unknown) can be loaded into a browser or similar application (step 212). The pruning module 116 can be used to identify any candidate elements on the web page (step 214). The feature extraction module 118 can be used to determine one or more features for each identified candidate element (step 216). The features for the candidate elements can then be input into the one or more classifiers 210 (e.g., included in or accessed by the outlier detection module 120), and the outlier detection module 120 can detect a layout of the new web page, including any information elements (step 218). In one example, the outlier detection module 120 provides a probability or score representing a likelihood that a candidate element is an information element. If the probability exceeds a threshold (e.g., 80% or 90%) for a candidate element, the candidate element can be considered to be an information element. In certain implementations, the outlier detection module 120 outputs a listing of any information elements identified among the candidate elements. The listing can include location information and/or content information for the information elements.

For e-commerce web pages, a web page element (e.g., a DOM element) can qualify as an information element if it represents or is associated with an SKU selection option. Typically, e-commerce product pages can have multiple such options corresponding to SKUs from different colors, sizes, and other SKU specific attributes. The systems and methods described herein are preferably used to automatically detect such elements, as their presence or absence on the web page defines a particular layout for the given merchant. A typical merchant could have multiple layouts represented by, for example, no SKU selection elements (layout A), only color selection elements (layout B), only size selection elements (layout C), color and size selection elements (layout D), or any such combinations.

If there are M merchants in an e-commerce system, and each merchant has Nₘ number of product pages P, then

Mm|1≦m≦M (1)

and

Pₙ^{m}n|1≦n≦Nₘ, (2)

where Pₙ^{m} represents product page n for merchant m. In general, equation (1) defines a collection of merchants m in the system, and equation (2) defines a collection of product pages P for the M merchants.

A layout function Γ(p) can be defined that maps each merchant product page p to a specific page layout L, according to

Γ(p):p!L (3)

and

LL|1≦L≦K. (4)

In equation (3), the layout function Γ(p) maps a given product page p to a particular page layout L. Equation (4) represents a particular layout L from a collection of a total number K of possible layouts for the system.

Each layout L can be further represented as a set of characteristic functions x over a set of information elements S, as follows:

χ [symbol] [symbol] :S→0,1. (5)

In one example, a layout L is or defines a unique combination of information elements on a web page page. For example, a website for a merchant can include only two types of information elements S: one for color (e.g., shirt color) and one for size (e.g., shirt size). Each product page for the merchant can then be classified to belong to one of four possible categories or layouts: color present, size absent (Layout 1); color absent, size present (Layout 2); color present, size present (Layout 3); color absent, size absent (Layout 4). In this example, the number of layouts is 4, and the layout L can be identified by an integer from [1,2,3,4], with L=1 denoting Layout 1, L=2 denoting Layout 2, L=3 denoting Layout 3, and L=4 denoting Layout 4.

Hence, the problem of detecting web page layout L can be reduced to detecting the information elements S. It is presently found that, across a number of product pages, many HTML DOM elements are repeated. This constitutes a “normal” data distribution over HTML elements that appear frequently.

In various implementations, web page elements corresponding to information elements are deviant or an “outlier” to this distribution. Hence, to detect information elements, examples of the systems and methods described herein use an “outlier detection” approach, as implemented in the outlier detection module 120.

A preferred predictive model or classifier for the outlier detection module 120 is one-class support vector machines (SVM). One-class SVM can be an extension of a regular SVM formulation. In the regular SVM formulation, a hyper plane can be constructed that maximizes a margin between two classes. By contrast, in one-class SVM, a hyper plane can be constructed that maximizes a margin from an origin of input data points in a given feature space F. The one-class SVM approach can identify regions in the input feature space F where a probability density of data is higher. In other words, the one-class SVM can finds a region where most of the data is located. Data that deviates from this region can be considered outlier data.

In certain examples, a typical e-commerce product page can contain thousands of DOM elements that form a DOM tree. Detecting layout specific elements in the DOM tree poses two issues. First, iterating over the complete DOM tree every time can be computationally expensive. Second, a large number of irrelevant DOM elements (e.g., DOM elements that have no information of interest) can lead to more noise in the data. To avoid such issues, the pruning module 116 is used to prune candidate elements from the full set of DOM elements on the web page. The feature extraction module 118 can then be used to extract features for the candidate elements. Advantageously, by performing feature extraction on only the candidate elements, which typically represent a small fraction of the total number of web page DOM elements, the systems and methods can avoid unnecessary calculations and/or identify information elements more efficiently and accurately.

In the context of e-commerce, a general purpose of information elements is to allow consumers to pick certain variants of products or SKUs. Hence most information elements contain or use some form of HTML interaction technique, which can be useful in an initial filtering of noisy DOM elements (e.g., during the pruning step). In some examples, information elements are or include color swatches, dropdowns, checkboxes, radio buttons, etc. Additionally or alternatively, the information elements often occur in groups, allowing users to select from multiple colors, sizes, etc. Based on such observations, certain constraints may be defined that allow candidate elements to be filtered or pruned from other web page elements, using the pruning module 116.

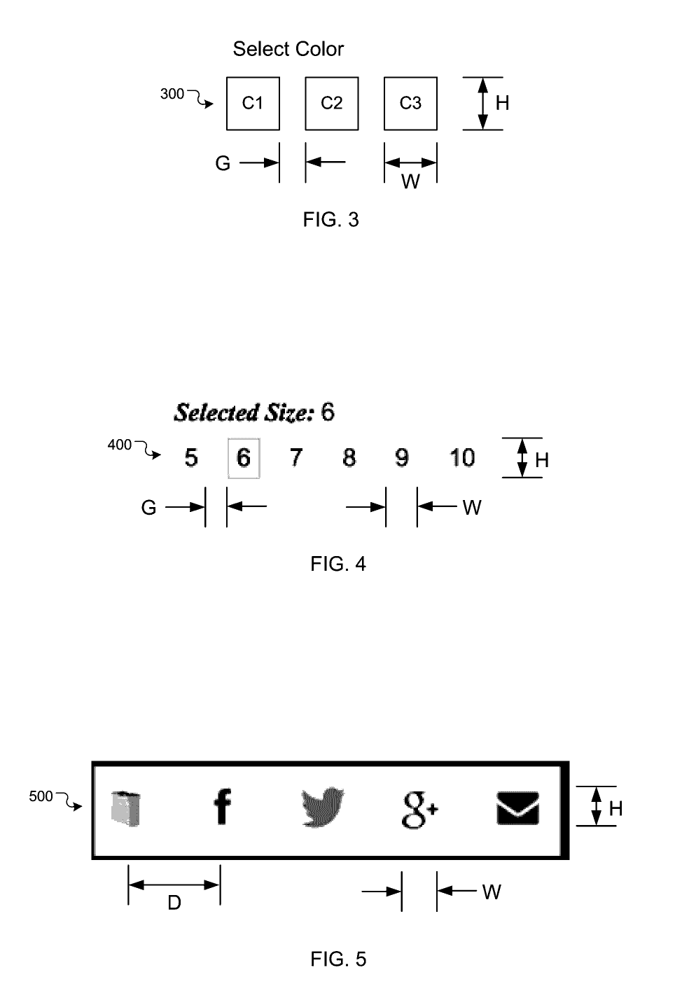

In various examples, a DOM element is chosen as a candidate element by the pruning module 116 when the DOM element obeys a padding constraint, a grouping constraint, and/or a size constraint. The padding constraint requires the candidate elements to have a consistent spacing or padding. For example, referring to elements 300 in FIG. 3, each element 300 is separated from a nearest neighboring element 300 by a gap G. Because of this consistent spacing, the padding constraint may be considered to be satisfied for the elements 300 and/or the elements 300 may be considered to be candidate elements. The padding constraint can also be satisfied for elements 400 in FIG. 4, due to the consistent gap G between the elements 400. In FIG. 5, elements 500 are not all the same size, but the elements have a consistent center-to-center spacing D. The elements 500 may be considered to satisfy the padding constraint due to this consistent spacing D. In various examples, when the gap G and/or the spacing D varies by less than a threshold amount (e.g., ±10% or 20%) for a group of elements, the padding constraint may be considered to be satisfied for the group of elements.

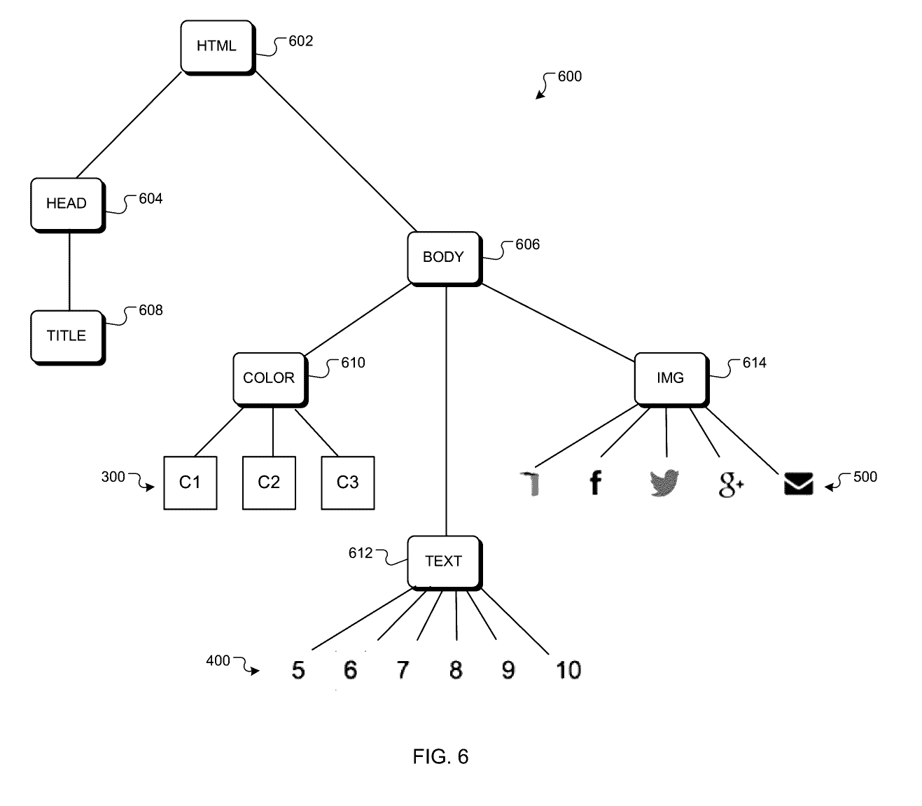

The grouping constraint requires the candidate elements to form a group of elements having different images, text (e.g., values), and/or colors. By way of illustration, FIG. 6 is a schematic representation of a DOM tag tree 600 for an example web page that includes various DOM tags and the elements 300, 400, and 500. The tag tree 600 includes an HTML tag 602, a HEAD tag 604, and a BODY tag 606. The HEAD tag 604 represents a header portion of the web page that includes a title associated with a TITLE tag 608. The BODY tag 606 represents a body portion of the web page that includes a COLOR tag 610, a TEXT tag 612, and an IMG tag 614. The COLOR tag 610 is a parent tag for elements 300, the TEXT tag 612 is a parent tag for the elements 400, and the IMG tag 614 is a parent tag for elements 500. In the depicted example, elements 300 are arranged in a group (e.g., they have the same parent COLOR tag 610) and have different colors C1, C2, and C3. Likewise, the elements 400 are arranged in a group (e.g., they have the same parent TEXT tag 612) and have different text (i.e., “5,” “6,” “7,” “8,” “9,” and “10”). The elements 500 are also arranged in a group (e.g., they have the same parent IMG tag 614) and have different images. As a result of these groupings and the different colors, text, and/or images in each group, elements 300, 400, and 500 may satisfy the grouping constraint and/or be considered to be candidate elements.

The size constraint requires candidate elements to fall within a certain range of sizes. Referring again to FIGS. 3, 4, and 5, for example, the size may be determined based on an element height H, an element width W, and/or an element area (e.g., a product of height H and width W). In some instances, for example, each candidate element is required to have the height H be from 0 pixels to 500 pixels and/or the width W be from 0 pixels to 500 pixels. The desired ranges for element height H, width W, and/or area can be determined empirically. When the sizes of elements 300, 400, or 500 fall within the desired range, the elements 300, 400, or 500 may satisfy the size constraint and/or be considered to be candidate elements.

Once the candidate elements have been pruned from a web page (e.g., using the pruning module 116), the systems and methods described herein can extract a set of features from the candidate elements. The features are generally designed to take into account DOM element content as well as DOM element visual rendering. The features can be or include, for example, dimension features, content features, and/or background features. Table 1 includes a listing of example dimension, content, and background features for candidate elements. As indicated in the table, dimension features for a candidate element may include a web page height, a web page width, an x-coordinate for the candidate element (e.g., measured from a left-hand edge of the web page), a y-coordinate for the candidate element (e.g., measured from a bottom edge of the web page), a height H of the candidate element, and/or a width W of the candidate element. Dimension features may be measured in any suitable units, including pixels, mm, cm, or inches, for example.

Content features generally relate to the content of one or more candidate elements. The content features can include, for example, a number of different colors (e.g., font colors or border colors), fonts, or images under a parent DOM tag, a type of text (e.g., numeric, alpha, or alphanumeric), and/or a length of text (e.g., a number of characters or words). For example, referring again to FIG. 6, the group of elements 300 includes three different colors C1, C2, and C3 under the COLOR tag 610. Likewise, the group of elements 400 includes six different types of text (e.g., “5,” “6,” “7,” “8,” “9,” and “10”) under the TEXT tag 610. Additionally, the group of elements 500 includes five different images under the IMG tag 614.

Background features can be or include, for example, a number of background colors or background images under a parent DOM tag. As an example, the group of elements 300 can include three different background colors C1, C2, and C3. The background colors can be presented underneath text or other elements on a web page. By contrast, the group of elements 400 includes foreground text (e.g., “5,” “6,” “7,” “8,” “9,” and “10”). The foreground text can overlay one or more background colors or images, in certain instances.

TABLE 1
Feature details.

| Category | Feature | Level | Description |
|---|---|---|---|
| Dimension | d_height | Document | Height of Page |
| | d_width | Document | Width of Page |
| | t_x | Tag | X* co-ordinate of Tag |
| | t_y | Tag | Y* co-ordinate of Tag |
| | t_height | Tag | Height of Tag |
| | t_width | Tag | Width of tag |
| Content | t_color | Tag | Number of different colors |
| | | | under Tag |
| | t_font | Tag | Number of different fonts |
| | | | under Tag |
| | t_images | Tag | Number of different images |
| | | | under Tag |
| | t_text_type | Tag | Type of text (Numeric, Alpha, |
| | | | AlphaNumeric, Others) |
| | t_text_length | Tag | Length of text |
| Background | t_b_color | Tag | Number of different back |
| | | | ground colors under Tag |
| | t_b_images | Tag | Number of different back |
| | | | ground images under Tag |

In certain examples, features are computed by rendering the web page in a browser (e.g., GOOGLE CHROME or FIREFOX). A browser automation tool can be used to interact with various web page elements and access different properties or features of the elements. For example, the browser automation tool can be instructed to march through candidate elements (e.g., in a tag tree) and extract the desired features for each candidate element. The browser automation tool can be included in or accessed and/or controlled by the feature extraction module 118.

In various examples, the browser automation tool can utilize three components: (1) instructions from a user; (2) a driver (e.g., SELENIUM) to interpret the user instructions and send associated commands to a web browser (e.g., FIREFOX or CHROME); and (3) the browser to execute the driver commands. For example, to fill in a form on a web page, a user can write code that provides data for the form (e.g., information to be added to the form) to the driver (e.g., SELENIUM). The driver can convert the data into a format that the browser will understand and send the converted data to the browser, along with any necessary commands for entering the form data. Upon receiving the data and the commands, the browser can enter the data into the form and submit the data, as though a human had used the browser to enter and submit the data manually. In this way, the browser automation tool can emulate a human's use of a browser to interact with the web page. The browser automation tool can traverse an entire tag tree for a web page and/or interact with the web page (e.g., select elements, click elements, count elements, measure elements, enter data, and/or reload the web page).

Once the features for the candidate elements are determined, the features can be input into the trained classifier of the outlier detection module 120. The classifier can receive as input one or more vectors of real-valued numbers corresponding to the features. An input vector can include, for example, numbers corresponding to all candidate elements on a web page. Alternatively or additionally, an input vector can include numbers for less than all the candidate elements on the web page (e.g., for only one candidate element or for only one group of candidate elements).

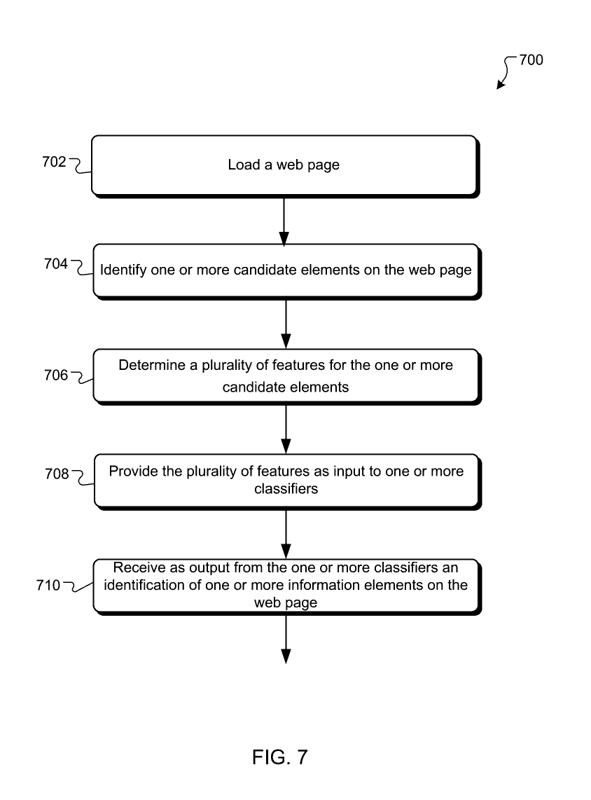

FIG. 7 is an example flowchart of a computer-implemented method 700 for detecting a web page layout and/or extracting web page information. The method includes loading a web page (step 702). One or more candidate elements on the web page are identified (e.g., using the pruning module 116), according to at least one of a padding constraint, a grouping constraint, and a size constraint (step 704). A plurality of features for the one or more candidate elements are determined (e.g., using the feature extraction module 118) (step 706). The features can include a dimension feature, a content feature, and/or a background feature. The plurality of features are provided as input to one or more classifiers (e.g., in the outlier detection module 120) (step 708). An identification of one or more information elements on the web page is received as output from the one or more classifiers (step 710). The information elements can include information of interest to one or more users.

A set of experiments was conducted on four large e-commerce websites to evaluate the performance of the systems and methods described herein. Table 2 includes a description of the four websites used for the experiments, including the number of web pages associated with each website.

TABLE 2
Dataset.

| Merchant | of Pages |
|---|---|
| M₁: Large Discount Store Chain | 640 |
| M₂: Large Department Store Chain | 281 |
| M₃: Large Online Shoes & Clothing Store | 278 |
| M₄: Mid-Range Department Store Chain | 223 |

In one experiment, the generalizability of the systems and methods was investigated. A single merchant's website data was used to train the classifier of the outlier detection module 120, and the trained classifier was then used to detect information elements on the websites of other merchants. All possible pairs of merchants were chosen and the overall accuracy of the systems and methods was determined. Table 3 illustrates the detection accuracy for different merchant pairs. As shown, the systems and methods are able to learn a generalizable representation of information elements and/or non-information elements based on training data obtained from a single merchant. Furthermore, this generalization capability is independent of the merchant website used for training, which is indicative of good performance for different merchant website training and testing combinations. In Table 3, columns represent training data and rows represent testing data.

TABLE 3
Model generalization against different merchants - detection accuracy.

| | M₁ | M₂ | M₃ | M₄ |
|---|---|---|---|---|
| M₁ | — | 75% | 69% | 72% |
| M₂ | 70% | — | 73% | 75% |
| M₃ | 72% | 70% | — | 68% |
| M₄ | 75% | 71% | 66% | — |
| Avg | 72% | 72% | 69% | 71% |

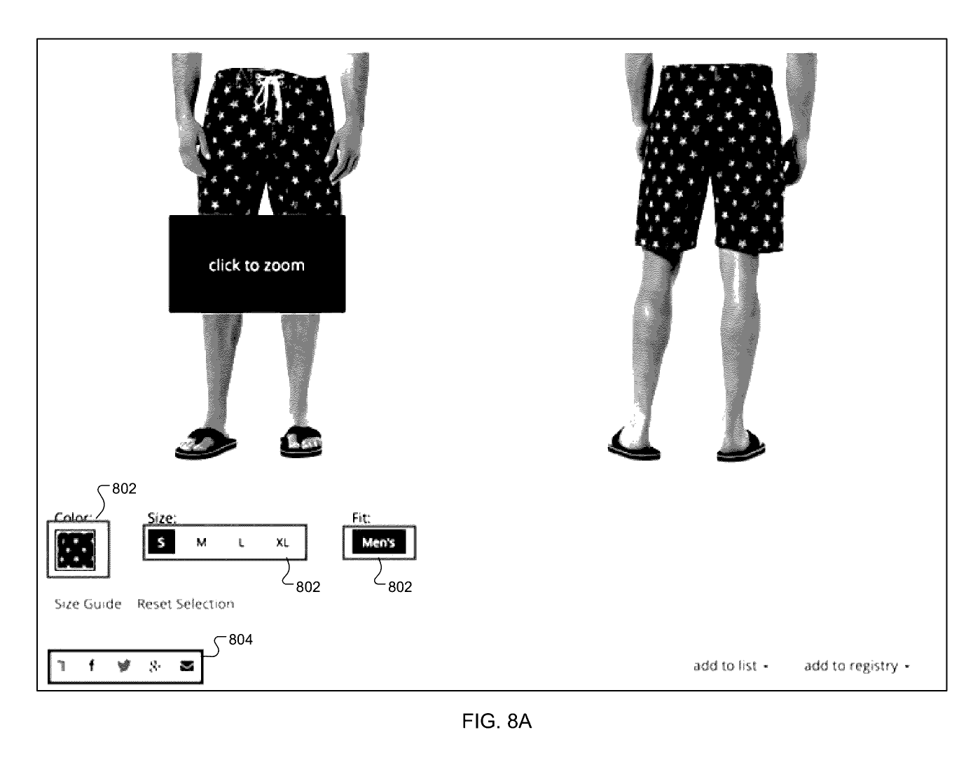

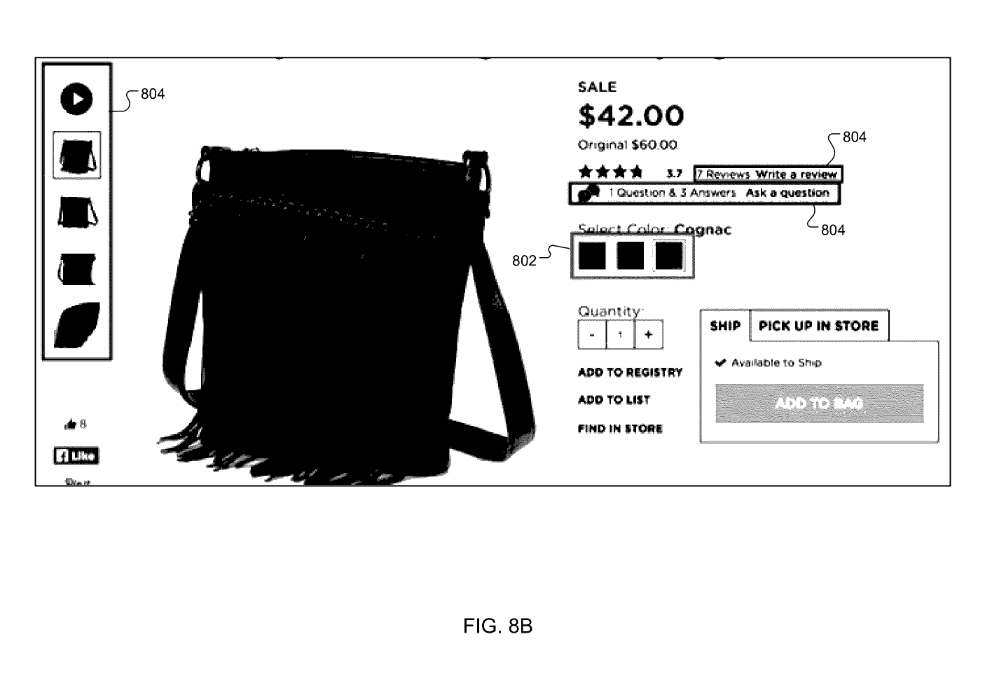

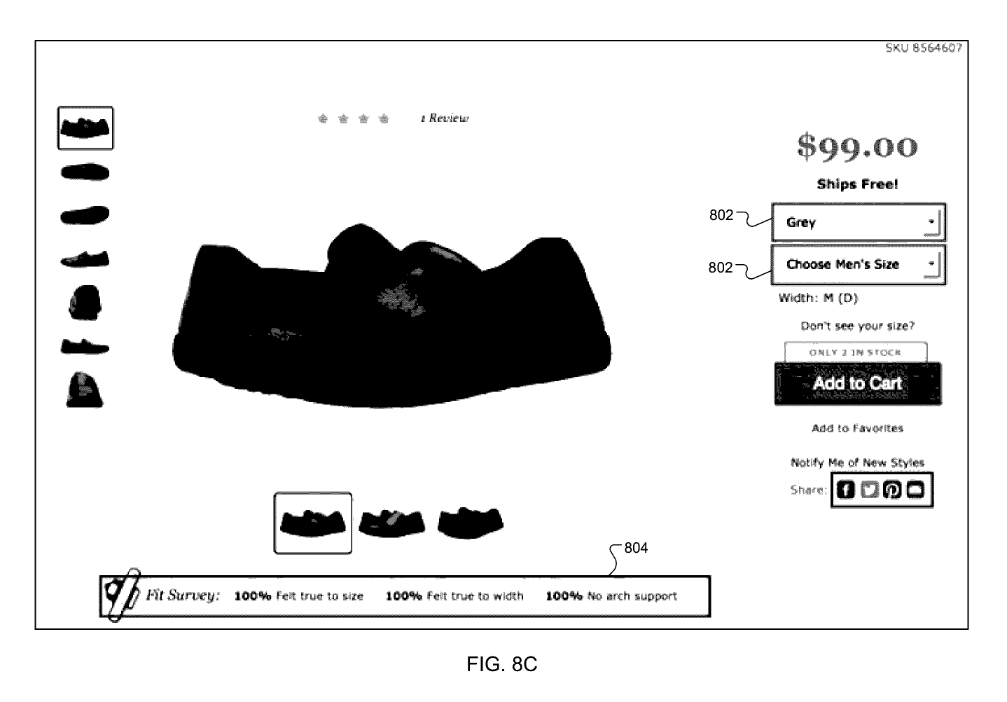

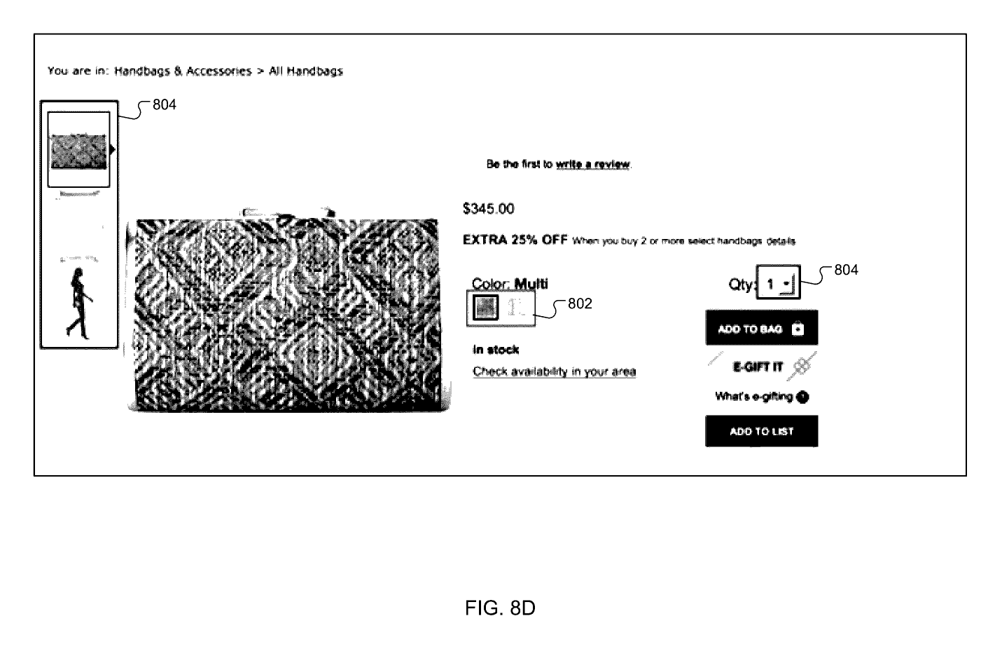

FIGS. 8A-8D are example screenshots from product pages for the four merchants M₁, M₂, M₃, M₄. Boxes 802 are drawn around information elements identified using the systems and methods described herein. Boxes 804 are drawn around candidate elements that were identified during the pruning step but were determined (e.g., using one or more classifiers) to not be information elements.

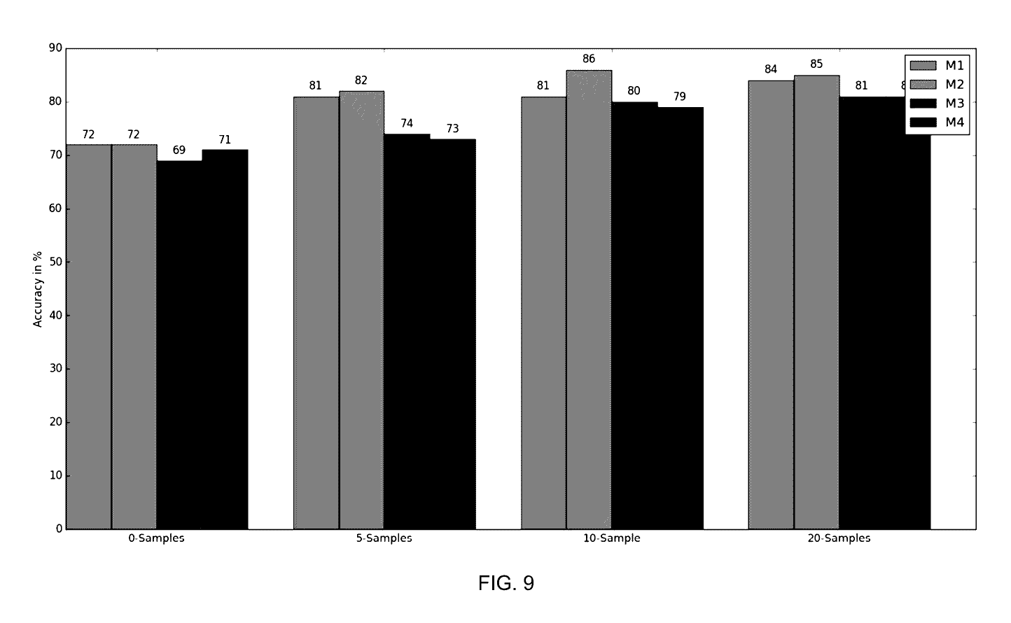

In another experiment, an investigation was performed to determine the effect of adding to the training data examples of non-information elements from web pages of additional merchants. The motivation for this study comes from the observation that, in general, there are readily available samples of non-information elements across merchants. Instead of trying to find information elements for every merchant, non-information elements can be added to training data (e.g., the training data 124), to improve the representation of “normal” HTML elements and the classifier's ability to distinguish information elements from non-information elements. To perform the investigation, 0, 5, 10 and 20 samples of non-information elements from each merchant were added to the testing set and to the original training set for the merchants. The overall testing accuracy was then computed across all merchant training and testing combinations. Results shown in FIG. 9 suggest that adding a few samples of non-information elements from diverse merchant sets leads to significant performance improvements. For example, prediction accuracy increased from about 70% to about 83% when the number of non-information element samples increased from 0 to 20. This behavior is consistent across all four merchants M₁, M₂, M₃ and M₄. In some instances, a semi-supervised framework can be used to perform this task (e.g., training the classifier with non-information elements).

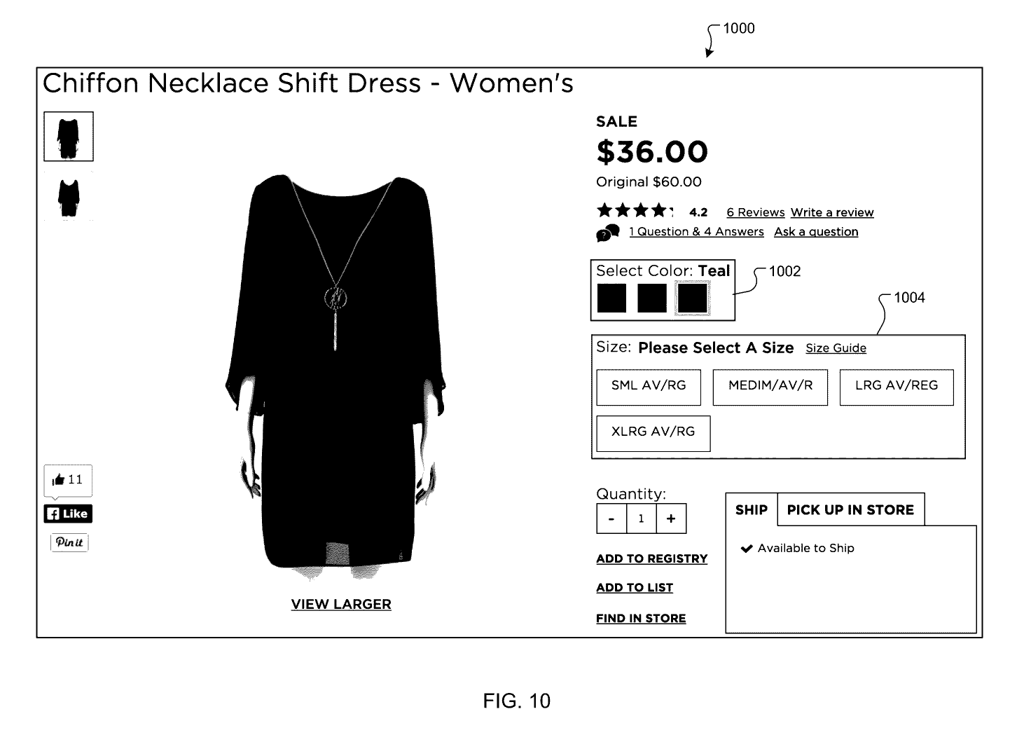

FIG. 10 is a screenshot of an example web page 1000 for a clothing merchant. After processing the web page using the systems and methods described herein, two groupings of information elements were identified on the web page. A first grouping of information elements is identified with a rectangle 1002 and relates to a color section option. A second grouping of information elements is identified with a rectangle 1004 and relates to a size selection option.

Embodiments of the systems and methods are able to determine web page layouts much faster and more accurately, compared to previous approaches. For example, a typical web page can include about 300 to 400 DOM tags. Extracting features for all of these tags can take about 1-2 min. After pruning the information element tags, however, the number of tags required for feature extraction can be reduced to around 10, and extraction of features for these tags can take about 5-10 seconds. Hence, an average speed increase of 12×-15× can be obtained with the systems and methods described herein. Much of this speed increase can be due to pruning the information elements and considering only those elements for feature extraction, rather than considering all possible web page elements.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a smart phone, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. It should be understood that the order of steps or order for performing certain actions is immaterial so long as the systems and methods remains operable. In certain implementations, multitasking and parallel processing may be advantageous, as two or more steps or actions may be conducted simultaneously.

What is claimed is:

1. A computer-implemented method of detecting a web page layout, the method comprising:
loading a web page;
identifying one or more candidate elements on the web page according to at least one of a padding constraint, a grouping constraint, and a size constraint;
determining a plurality of features for the one or more candidate elements, the features comprising at least one of a dimension feature, a content feature, and a background feature;
providing the plurality of features as input to one or more classifiers; and
receiving as output from the one or more classifiers an identification of one or more information elements on the web page, the information elements comprising information of interest to one or more users.

2. The method of claim 1, wherein loading the web page comprises loading the web page in a browser.

3. The method of claim 1, wherein the one or more candidate elements are identified according to the padding constraint, and wherein the padding constraint requires candidate elements to have a consistent spacing.

4. The method of claim 1, wherein the one or more candidate elements are identified according to the grouping constraint, and wherein the grouping constraint requires (i) candidate elements to form a group and (ii) each candidate element in the group to comprise at least one of a unique color, a unique image, and unique text.

5. The method of claim 1, wherein the one or more candidate elements are identified according to the size constraint, and wherein the size constraint requires candidate elements to comprise a size that falls within a specified range.

6. The method of claim 1, wherein the features comprise the dimension feature comprising at least one of a web page height, a web page width, an x-coordinate, a y-coordinate, a height H, and a width W.

7. The method of claim 1, wherein the features comprise the content feature comprising at least one of a number of colors, a number of fonts, a number of images, a type of text, and a length of text.

8. The method of claim 1, wherein the features comprise the background feature comprising at least one of a number of background colors and a number of background images.

9. The method of claim 1, wherein extracting features comprises traversing a tag tree in the web page.

10. The method of claim 1, wherein the one or more classifiers comprise a one-class support vector machines algorithm.

11. The method of claim 1, wherein the one or more candidate elements comprise the one or more information elements.

12. The method of claim 1, further comprising training the classifier with training data comprising features for web page elements.

13. The method of claim 1, further comprising extracting information of interest from at least one of the one or more information elements.

14. A system comprising:
a data processing apparatus programmed to perform operations for detecting a web page layout, the operations comprising:
loading a web page;
identifying one or more candidate elements on the web page according to at least one of a padding constraint, a grouping constraint, and a size constraint;
determining a plurality of features for the one or more candidate elements, the features comprising at least one of a dimension feature, a content feature, and a background feature;
providing the plurality of features as input to one or more classifiers; and
receiving as output from the one or more classifiers an identification of one or more information elements on the web page, the information elements comprising information of interest to one or more users.

15. The system of claim 14, wherein the one or more candidate elements are identified according to the padding constraint, and wherein the padding constraint requires candidate elements to have a consistent spacing.

16. The system of claim 14, wherein the one or more candidate elements are identified according to the grouping constraint, and wherein the grouping constraint requires (i) candidate elements to form a group and (ii) each candidate element in the group to comprise at least one of a unique color, a unique image, and unique text.

17. The system of claim 14, wherein the one or more candidate elements are identified according to the size constraint, and wherein the size constraint requires candidate elements to comprise a size that falls within a specified range.

18. The system of claim 14, wherein the one or more classifiers comprise a one-class support vector machines algorithm.

19. The system of claim 14, wherein the one or more candidate elements comprise the one or more information elements.

20. A non-transitory computer storage medium having instructions stored thereon that, when executed by data processing apparatus, cause the data processing apparatus to perform operations for detecting a web page layout, the operations comprising:
loading a web page;
identifying one or more candidate elements on the web page according to at least one of a padding constraint, a grouping constraint, and a size constraint;
determining a plurality of features for the one or more candidate elements, the features comprising at least one of a dimension feature, a content feature, and a background feature;
providing the plurality of features as input to one or more classifiers; and
receiving as output from the one or more classifiers an identification of one or more information elements on the web page, the information elements comprising information of interest to one or more users.
